(19) United States
(12) Patent Application Publication
(10) Pub. No.: US 2018/0097858 A1
(43) Pub. Date: Apr. 5, 2018

(54) EMBEDDED SIDE CALL SUB-CHANNEL USED IN A TELECOMMUNICATION SESSION

(71) Applicant: International Business Machines Corporation, Armonk, NY (US)

(72) Inventors: CANDICE B. GILZEAN, AUSTIN, TX (US); MARIA DE LOURDES HARRISON, LITTLE ROCK, AR (US); BRENT L. LANN, WYLIE, TX (US); CHRISTINA W. MACRAE, HOUSTON, TX (US); BARRY P. ROBICHAUX, KINGWOOD, TX (US); KEITH R. WALKER, AUSTIN, TX (US); CAMERON J. WINGERS, OVERLAND PARK, KS (US)

(21) Appl. No.: 15/284,764

(22) Filed: Oct. 4, 2016

(51) Int. Cl. H04L 29/06; H04M 3/56

(52) U.S. Cl. CPC H04L 65/4015; H04M 2203/2011; H04M 3/564

(57) ABSTRACT

A computer-implemented method, system, and/or computer program product establishes an embedded side call telecommunication session via a sub-channel in a telecommunication session. A telecommunication server establishes a primary telecommunication session on a primary channel and a secondary telecommunication session on a sub-channel. The telecommunication server receives a secondary rerouting request from a specific secondary participant to the secondary telecommunication session. The telecommunication server executes the secondary rerouting request. Executing the secondary rerouting request redirects only secondary telecommunication transmissions from the specific secondary participant from the sub-channel to the primary channel, and telecommunication transmissions from other participants to the secondary telecommunication session are unavailable to the primary telecommunication session.

### BACKGROUND

The present disclosure relates to the field of telecommunication sessions, and specifically to communication channels used in telecommunication sessions. Still more specifically, the present disclosure relates to sub-channels used in a telecommunication session.

### SUMMARY

A computer-implemented method, system, and/or computer program product establishes an embedded side call telecommunication session via a sub-channel in a telecommunication session. A telecommunication server establishes a primary telecommunication session on a primary channel and a secondary telecommunication session on a sub-channel. The primary telecommunication session and the secondary telecommunication session are separate telecommunication sessions that are not joined. The telecommunication server receives a secondary rerouting request from a specific secondary participant to the secondary telecommunication session. The telecommunication server executes the secondary rerouting request. Executing the secondary rerouting request redirects only secondary telecommunication transmissions from the specific secondary participant from the sub-channel to the primary channel, and telecommunication transmissions from other participants to the secondary telecommunication session are unavailable to the primary telecommunication session.

### BRIEF DESCRIPTION OF THE DRAWINGS

FIG. 1 depicts an exemplary system and network in which the present disclosure may be implemented;

FIG. 2 illustrates a relationship between a telecommunications server and multiple telecommunication client devices in accordance with one or more embodiments of the present invention;

FIG. 3 depicts telecommunication transmissions being rerouted between a primary channel and a sub-channel in accordance with one or more embodiments of the present invention;

FIG. 4A and FIG. 4B are a high-level overview of one or more embodiments of the present invention; and

FIG. 5 is a high-level flow chart of one or more steps performed by a telecommunication server in accordance with one or more embodiments of the present invention.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As indicated above, various embodiments of the present invention relate to telecommunication sessions, such as conference calls, televideo conferences, etc. There are instances when participants on a conference call or web conferencing service need to speak privately while still being able to listen in on the call. Various solutions found in the prior art are cumbersome.

For example, a participant may be part of a multi-party conference call on one device (e.g., a videoconference terminal) while privately talking to a particular person from the multi-party conference call on another device (e.g., a cell phone) or on another program (e.g., a short message service—SMS texting program). This requires access to a secondary device, which is not always possible, especially if participants are in transit. It also requires all participants to watch their secondary device, which is not always feasible, especially if the participants are “multi-tasking”.

A participant to a multi-party conference call may leave the multi-party conference call to go to a “private calling group”. However, switching to the private calling group requires the participant to leave the main multi-party conference call.

To overcome the drawbacks of the current art, the present invention provides a novel conference call and web conferencing service that allows a single channel to be split into a primary channel and a secondary sub-channel. Note that the use of the term “secondary sub-channel” does not limit the number of sub-channels that can be established by the method.

One or more embodiments of the present invention provide a system that allows a subset of participants of a conference call or web conferencing service to converse while still being able to participate in the primary call by using sub-channels with coordination by the conference provider. The methods of the invention enable participants to manage the complexity inherent in such a multi sub-channel call.

The high-level overview of one or more embodiments of the present invention includes:

1. Detecting a line request from a primary channel to create or join a sub-channel (which may include authentication, such as a code typed on the keypad);

2. Connecting the line request to the sub-channel;

3. Responsive to receiving a broadcast on the primary channel, transmitting the broadcast to all lines configured to receive the primary channel (which may include optional volume control, such as reducing relative volume from the primary channel);

4. Responsive to receiving a broadcast on the sub-channel, transmitting the broadcast to all lines connected to the sub-channel; and

5. Responsive to receiving a request from a line connected to a sub-channel to switch the broadcast to the primary or the sub-channel, transmitting any subsequent broadcast from the line to the corresponding channel.

Note that for one or more embodiments in which the teleconference is a videoconference, joining a sub-channel will preferably mask the user's video feed from the primary channel and give an indicator that the user is in a sub-channel. This avoids confusion among participants and prevents possible privacy concerns due non-members of the sub-channel being able to see, if not hear, the conversation from the sub-channel.

The conference service receives broadcasts from all lines. The conference service stores in memory the current settings for each line (whether the line is connected to a sub-channel and optional line-specified volume controls if in a sub-channel). The conference service transmits to each line the channels that apply to the line (and optionally at the volume specified by the line). The conference service provides a method for a line to specify which channel it should broadcast to, and stores this setting in memory.

In a preferred embodiment, the presently-disclosed system provides the features of:

1. Participants of the first sub-channel do not participate in a second sub-channel of which they are not a participant.

2. Participants of the first sub-channel are able to create, join, leave, or disband a second sub-channel. Permissions govern these activities in the preferred embodiment.

3. Participants of a second sub-channel are able to participate in the first sub-channel and vice versa by switching back and forth between sub-channels.

In accordance with one or more embodiments of the present invention, a telecommunications server provides a means to create sub-channels that permit participants to have a private communication channel while still receiving transmission from the primary channel. Often this means will be via touchtones sent from a phone. For example, participants could enter *1234 to create a sub-channel, and be prompted to supply a participant numeric password. Other participants could enter *12345 to enter a sub-channel, upon which they would be prompted to supply the numeric password. Still other touchtone commands can be used to then control the following aspects of the primary and sub-channels with respect to a) what they receive and b) where they transmit. For example, once in a sub-channel, *1 might be used by a participant to instruct the server component that transmissions from their line should be over the primary channel, and then *2 could revert back to transmitting only on the sub-channel. Similarly, *3 might be used to enter into a volume control mode of the primary channel, wherein they could be prompted to enter a volume of audio received on that channel, such as numbers 0-9 with 9 being the loudest. Likewise, *4 might be used to enter into a volume control mode of the sub-channel, wherein they could be prompted to enter a volume of audio received on that channel, such as numbers 0-9 with 9 being the loudest. In this way the users can control the volume that they receive from both channels in addition to controlling what channel their voice transmits to.

The server component then modifies the audio output to the participant's line according to the commands it has received using the enabling technology (audio is transformed digitally via audio processing such as combining audio streams and transforming one or both of the audio streams).

A database table structure that would enable this invention in the server component is as follows:
Table: Conference Line
Fields: Conference Line ID
Notes: In the art this main table may include many other fields, such as start and end times, recording status, moderator status, etc. For our purposes, we just use the concept of a conference line.
Table: Sub-Conference Channel
Fields: foreign key to the Conference Line ID of table Conference Line; Sub-Conference ID; Passcode
Table: Participants
Fields: foreign key to the Conference Line ID of table Conference Line; Participant ID; foreign key to the Sub-Conference Channel; Active Transmit Channel; Conference Line Volume; Sub-Conference Channel Volume
Notes: In the art this table may include other fields used by the conference calling center, such as join time, leave time, link to a user profile or LDAP authentication, IP Address, mute status, etc.
Optional Table: Participant Preferences
Fields: Participant ID; Default Active Transmit Channel; Default Conference Line Volume; Default Sub-Conference Channel Volume
Note: This table would be queried when a participant joins a sub-conference channel (sub-channel) to establish the initial conditions. In the preferred embodiment, the user's line would receive a system announcement, such as which channel they will transmit to, optional channel volumes, an optional mute status, and optional instructions on how to toggle the transmit channel and volumes.

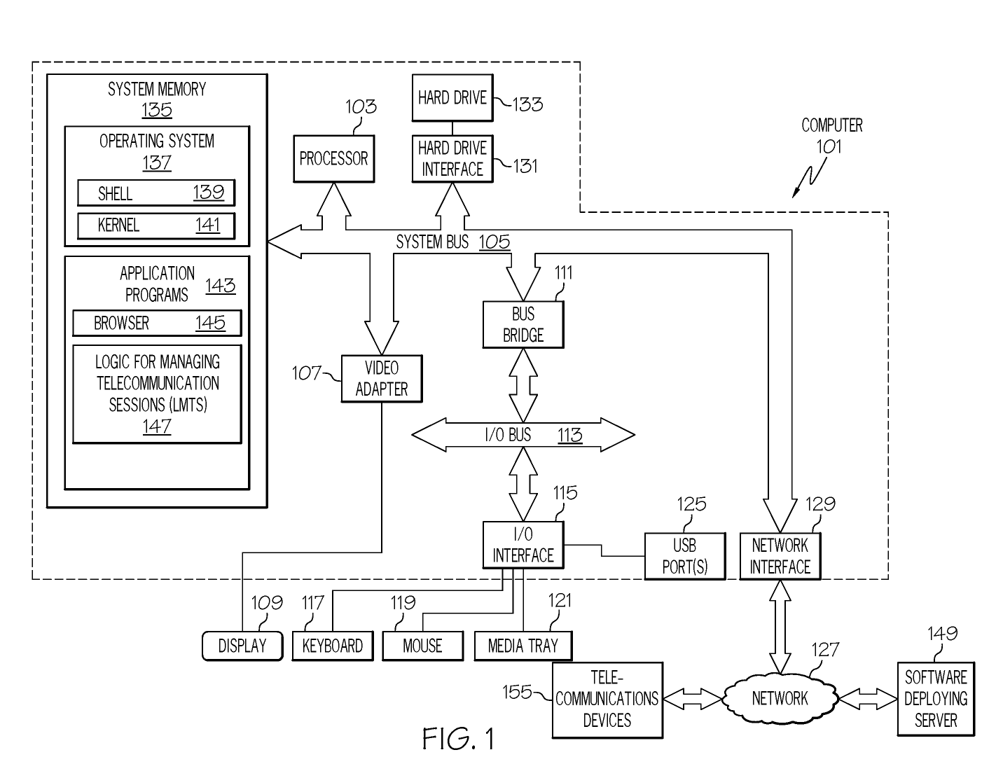

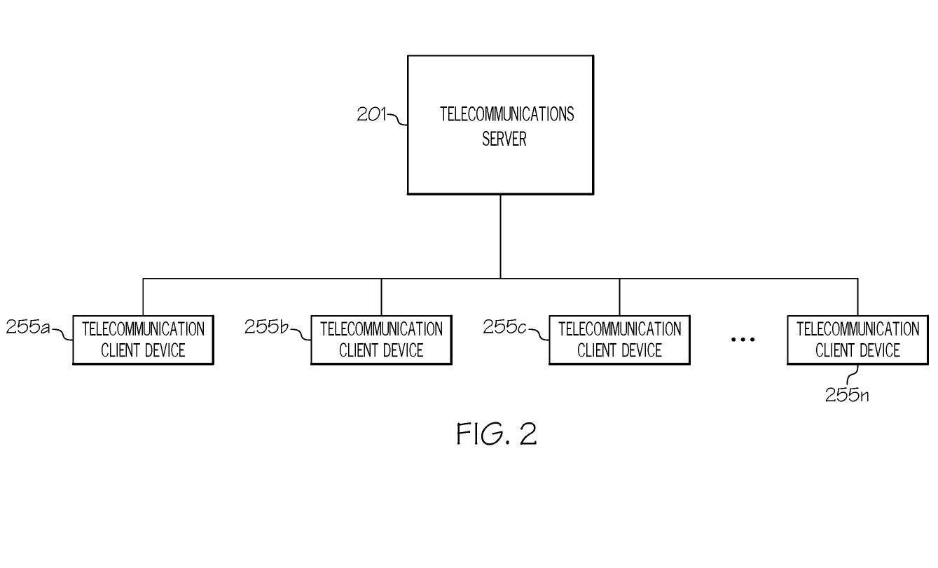

With reference now to the figures, and in particular to FIG. 1, there is depicted a block diagram of an exemplary system and network that may be utilized by and/or in the implementation of the present invention. Some or all of the exemplary architecture, including both depicted hardware and software, shown for and within computer 101 may be utilized by software deploying server 149 and/or telecommunication devices 155 shown in FIG. 1, telecommunication server 201 shown in FIG. 2, and/or one or more of the telecommunication client devices 255a-255n shown in FIG. 2.

Exemplary computer 101 includes a processor 103 that is coupled to a system bus 105. Processor 103 may utilize one or more processors, each of which has one or more processor cores. A video adapter 107, which drives/supports a display 109, is also coupled to system bus 105. System bus 105 is coupled via a bus bridge 111 to an input/output (I/O) bus 113. An I/O interface 115 is coupled to I/O bus 113. I/O interface 115 affords communication with various I/O devices, including a keyboard 117, a mouse 119, a media tray 121 (which may include storage devices such as CD-ROM drives, multi-media interfaces, etc.), and external USB port(s) 125. While the format of the ports connected to I/O interface 115 may be any known to those skilled in the art of computer architecture, in one embodiment some or all of these ports are universal serial bus (USB) ports.

As depicted, computer 101 is able to communicate with software deploying server 149 and/or telecommunication devices 155 using a network interface 129. Network interface 129 is a hardware network interface, such as a network interface card (NIC), etc. Network 127 may be an external network such as the Internet, or an internal network such as an Ethernet or a virtual private network (VPN). In one or more embodiments, network 127 is a wireless network, such as a Wi-Fi network, a cellular network, etc.

A hard drive interface 131 is also coupled to system bus 105. Hard drive interface 131 interfaces with a hard drive 133. In one embodiment, hard drive 133 populates a system memory 135, which is also coupled to system bus 105. System memory is defined as a lowest level of volatile memory in computer 101. This volatile memory includes additional higher levels of volatile memory (not shown), including, but not limited to, cache memory, registers and buffers. Data that populates system memory 135 includes computer 101's operating system (OS) 137 and application programs 143.

OS 137 includes a shell 139, for providing transparent user access to resources such as application programs 143. Generally, shell 139 is a program that provides an interpreter and an interface between the user and the operating system. More specifically, shell 139 executes commands that are entered into a command line user interface or from a file. Thus, shell 139, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 141) for processing. While shell 139 is a text-based, line-oriented user interface, the present invention will equally well support other user interface modes, such as graphical, voice, gestural, etc.

As depicted, OS 137 also includes kernel 141, which includes lower levels of functionality for OS 137, including providing essential services required by other parts of OS 137 and application programs 143, including memory management, process and task management, disk management, and mouse and keyboard management.

Application programs 143 include a renderer, shown in exemplary manner as a browser 145. Browser 145 includes program modules and instructions enabling a world wide web (WWW) client (i.e., computer 101) to send and receive network messages to the Internet using hypertext transfer protocol (HTTP) messaging with telecommunication devices 155.

Application programs 143 in computer 101's system memory (as well as software deploying server 149's system memory) also include Logic for Managing Telecommunication Sessions (LMTS) 147. LMTS 147 includes code for implementing the processes described below, including those described in FIGS. 2-5. In one embodiment, computer 101 is able to download LMTS 147 from software deploying server 149, including in an on-demand basis, wherein the code in LMTS 147 is not downloaded until needed for execution. In one embodiment of the present invention, software deploying server 149 performs all of the functions associated with the present invention (including execution of LMTS 147), thus freeing computer 101 from having to use its own internal computing resources to execute LMTS 147.

The hardware elements depicted in computer 101 are not intended to be exhaustive, but rather are representative to highlight essential components required by the present invention. For instance, computer 101 may include alternate memory storage devices such as magnetic cassettes, digital versatile disks (DVDs), Bernoulli cartridges, and the like. These and other variations are intended to be within the spirit and scope of the present invention.

With reference now to FIG. 2, a relationship between a telecommunications server 201 and multiple telecommunication client devices 255a-255n (where “n” is an integer) in accordance with one or more embodiments of the present invention is presented. Telecommunications server 201 includes call processing logic, switches, signal transmitters, private branch exchange (PBX) hardware, etc. that enable the initiation and management of communication sessions among the telecommunication client devices 255a-255n via telecommunications server 201. These communication sessions, which may be audio, video, and/or audio-video, are established over a network (not shown) such as a private network (e.g., over an Ethernet), a public network (e.g., the Internet), a wireless network (e.g., a cellular network), a public phone system, the World Wide Web (e.g., using web portals), etc.

The telecommunication client devices 255a-255n may be computers, smart phones, and/or any other network-enabled device capable of engaging in a telecommunication session.

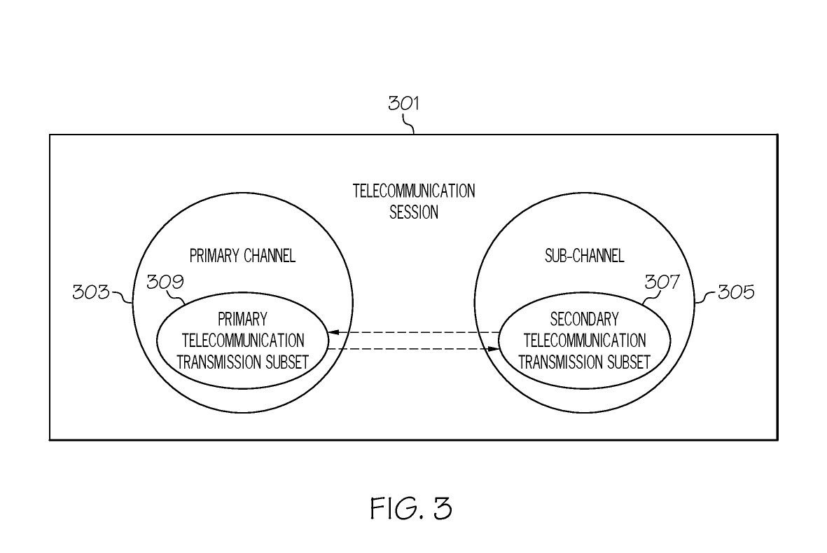

As shown in FIG. 3, consider exemplary telecommunication session 301. Initially, telecommunication session 301 is conducted over a primary channel 303, which is a telecommunication channel provided by a public network, a private network, a phone system, etc. that is capable of transmitting/conducting telecommunication messages/packets/etc. Primary channel 303 is used by the telecommunication server 201 shown in FIG. 2 to establish a primary telecommunication session among the telecommunication client devices 255a-255n. In accordance with one or more embodiments of the present invention, a sub-channel 305 is used by the telecommunication server 201 shown in FIG. 2 to establish a secondary telecommunication session among the telecommunication client devices 255a-255n. Initially, telecommunication transmissions on the sub-channel 305 cannot be heard/detected on the primary channel 303, and telecommunication transmissions on the primary channel 303 cannot be heard/detected on the sub-channel 305.

However, in accordance with the present invention, a certain secondary telecommunication transmission subset 307 can be selectively rerouted to the primary channel 303, and/or a certain primary telecommunication transmission subset 309 can be rerouted to the sub-channel 305. This rerouting of telecommunication transmission subsets allows other telecommunication transmissions to remain isolated while rerouting only telecommunication transmissions from specific users. That is, while telecommunication transmissions from a particular user of the sub-channel 305 (i.e., secondary telecommunication transmission subset 307) are rerouted to the primary channel 303, other telecommunication transmissions from other users of sub-channel 305 remain isolated from primary channel 303 (i.e., cannot be heard/seen by users of the primary channel 303). Similarly, when telecommunication transmissions from a particular user of the primary channel 303 (i.e., primary telecommunication transmission subset 309) are rerouted to the secondary channel 305, other telecommunication transmissions from other users of primary channel 303 remain isolated from secondary channel 305 (i.e., cannot be heard/seen by users of the secondary channel 305).

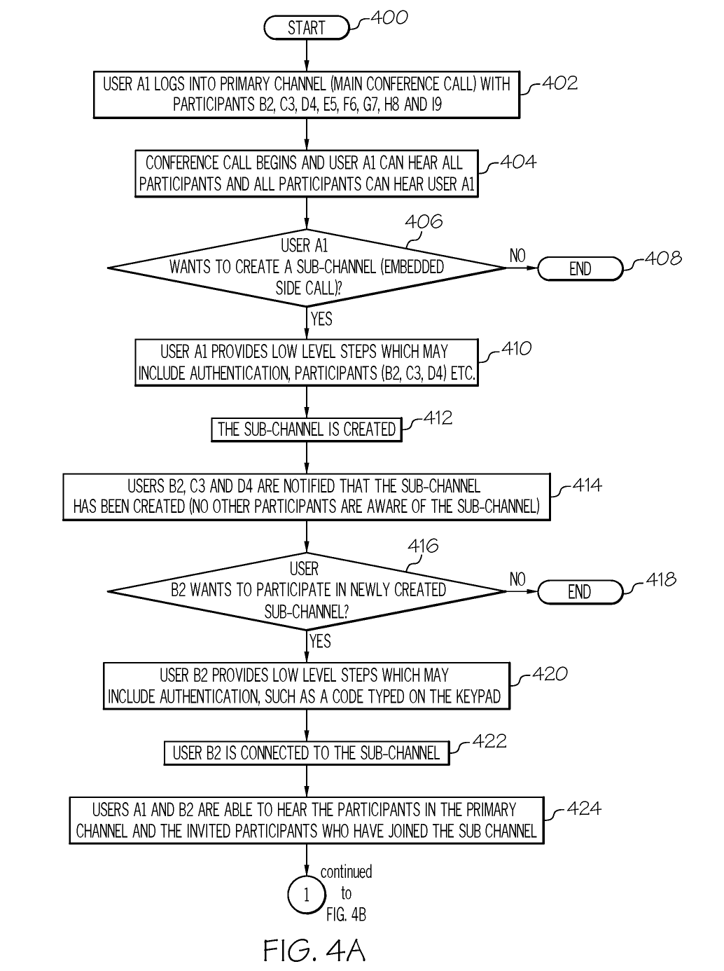

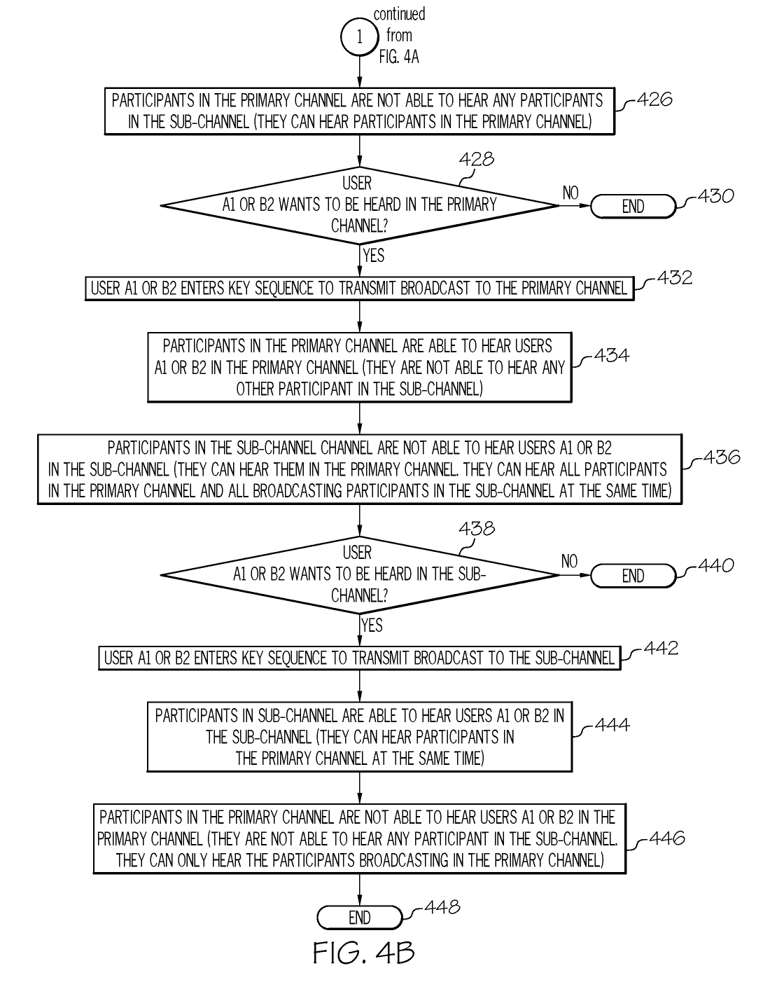

With reference now to FIG. 4A and FIG. 4B, a high-level overview of one or more embodiments of the present invention is presented.

After initiator block 400, user A1 logs into a primary channel (e.g., a main conference call conducted on the primary channel 303 shown in FIG. 3) along with participants B2, C3, D4, E5, F6, G7, H8 and I9, as described in block 402. This primary channel supports a primary telecommunication session among participants A1, B2, C3, D4, E5, F6, G7, H8 and I9.

As shown in block 404, the conference call begins and user A1 can hear all participants and all participants can hear user A1 on the primary telecommunication session.

As shown in query block 406, a query is made by the telecommunication server (e.g., telecommunication server 201 shown in FIG. 2) regarding whether or not User A1 wants to create a sub-channel (embedded side call), such as sub-channel 305 shown in FIG. 3. If not, the process ends at terminator block 408. However, if so, then User A1 (actually, telecommunication client device 355a) provides the telecommunication server with low level steps for establishing the primary communication session, such as authentication procedures (e.g., what passwords are required to join the secondary communication session), which participants are invited to join the secondary communication session (e.g., participants B2, C3, D4), etc.

As depicted in block 412, the telecommunication server creates the sub-channel, and exemplary Users B2, C3 and D4 are notified that the sub-channel has been created, as depicted in block 414. This notification is only sent to Users B2, C3 and D4, such that no other participants of the primary telecommunication session are aware of the fact that the sub-channel has been created.

As depicted in query block 416, the telecommunication server queries User B2 to determine if User B2 wants to participate in the newly created sub-channel. If not, the process ends at terminator block 418. However, if so, then User B2 provides the requisite information for joining the newly-created sub-channel, such as an authentication code typed on a keypad, as described in block 420. As depicted in block 422, User B2 is connected to the sub-channel, such that Users A1 and B2 are able to hear the participants in the primary channel and the invited participants who have joined the sub channel (block 424). As described in block 426, at this initial stage participants in the primary channel are not able to hear any participants in the sub-channel, although they can hear participants in the primary channel.

As described in query block 428, the telecommunication server queries User A1 or B2 as to whether User A1 or B2 wants to be heard in the primary channel. If not, the flow chart ends at terminator block 430. However, if so, then User A1 or B2 enters a key sequence to transmit a broadcast message to the telecommunication server, directing the telecommunication server to make the previously isolated (from the primary channel) telecommunication transmissions from User A1 or B2 be rerouted to the primary channel, as described in block 432.

As described in block 434, other participants in the primary channel are now able to hear Users A1 or B2 in the primary channel, although these other participants in the primary channel are not able to hear any other participant telecommunication transmissions (i.e., those not coming from Users A1 or B2) from the sub-channel.

As described in block 436, participants in the sub-channel channel are no longer able to hear Users A1 or B2 in the sub-channel, although they can still hear them in the primary channel (assuming that they are still participants in the sub-channel). That is, participants in the sub-channel can hear all participants in the primary channel and all broadcasting participants in the sub-channel at the same time.

As described in query block 438, the telecommunication server queries User A1 and/or B2 to ascertain whether or not User A1 or B2 wants to be heard in the sub-channel, since they are now being heard in the primary channel. If not, the process ends at terminator block 440. If so, however, then User A1 or B2 enters and transmits a key sequence to the telecommunication server directing the telecommunication server to reroute/broadcast telecommunication transmissions by User A1 or B2 from the primary channel to the sub-channel, as described in block 442.

As described in block 444, participants in the sub-channel are now able to hear Users A1 or B2 in the sub-channel. As also described in block 444, participants in the sub-channel can hear other participants in the primary channel at the same time as well. However, as described in block 446, participants in the primary channel are not able to hear Users A1 or B2 in the primary channel, since their telecommunication transmissions are once again isolated to the sub-channel.

The flow chart ends at terminator block 448.

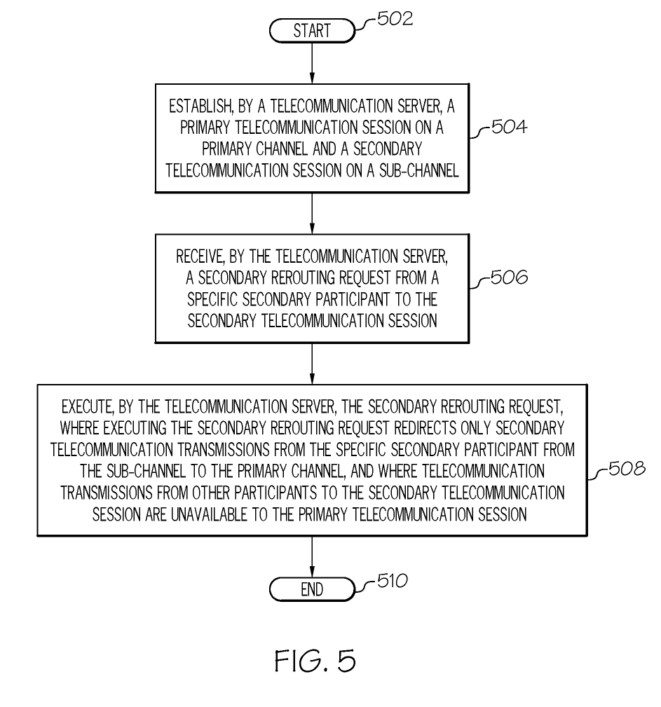

FIG. 5 is a high-level flow chart of one or more steps performed by a telecommunication server to establish an embedded side call telecommunication session via a sub-channel in a telecommunication session in accordance with one or more embodiments of the present invention.

After initiator block 502, a telecommunication server (e.g., telecommunication server 201 shown in FIG. 2) establishes a primary telecommunication session on a primary channel (e.g., primary channel 303 shown in FIG. 3) and a secondary telecommunication session on a sub-channel (e.g., sub-channel 305 shown in FIG. 3), as described in block 504. As described herein, telecommunication transmissions in the secondary telecommunication session are initially unavailable to the primary telecommunication session (i.e., cannot be seen/heard by participants to the primary telecommunication session), and telecommunication transmissions in the primary telecommunication session are initially unavailable to the secondary telecommunication session (i.e., cannot be seen/heard by participants to the secondary telecommunication session).

As described in block 506, the telecommunication server receives a secondary rerouting request from a specific secondary participant to the secondary telecommunication session. This secondary rerouting request asks the telecommunication server to make telecommunication transmissions from the secondary communication session made by this specific secondary participant, and no other participant to the secondary communication session, available to the primary telecommunication session.

As described in block 508, the telecommunication server executes the secondary rerouting request, such that executing the secondary rerouting request redirects only secondary telecommunication transmissions from the specific secondary participant from the sub-channel to the primary channel. However, telecommunication transmissions from other participants to the secondary telecommunication session continue to be unavailable to the primary telecommunication session.

The flow chart ends at terminator block 510.

In an embodiment of the present invention, the rerouting goes in the other direction (from the primary channel to the sub-channel). That is, in this embodiment, the telecommunication server receives a primary rerouting request from a specific primary participant to the primary telecommunication session. This primary rerouting requests reroutes telecommunication transmissions from this specific primary participant (i.e., a particular participant to the primary telecommunication session) to the sub-channel/secondary telecommunication session. Thus, the telecommunication server executes the primary rerouting request, such that executing the primary rerouting request redirects only primary telecommunication transmissions from the specific primary participant from the primary channel to the sub-channel. However, telecommunication transmissions from other participants to the primary telecommunication session continue to be unavailable to the secondary telecommunication session.

In an embodiment of the present invention, the primary communication session and the secondary communication session are both audio-only communication sessions (e.g., phone conferences), in which all communications are formatted in voice-only format (e.g., using a Voice over Internet Protocol—VoIP format).

In an embodiment of the present invention, the primary communication session and the secondary communication session are both audio-video communication sessions (e.g., using a video conferencing standard such as video packet transmission format).

In an embodiment of the present invention, the primary communication session is an audio communication session and the secondary communication session is an audio-video communication session.

In an embodiment of the present invention, the primary communication session is an audio-video communication session and the secondary communication session is an audio communication session.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the present invention in the form disclosed. Many modifications and variations will be apparent to those of ordinary skill in the art without departing from the scope and spirit of the present invention. The embodiment was chosen and described in order to best explain the principles of the present invention and the practical application, and to enable others of ordinary skill in the art to understand the present invention for various embodiments with various modifications as are suited to the particular use contemplated.

Any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the present invention of the present application in detail and by reference to illustrative embodiments thereof, it will be apparent that modifications and variations are possible without departing from the scope of the present invention defined in the appended claims.

What is claimed is:

1. A method of establishing an embedded side call telecommunication session via a sub-channel in a telecommunication session, the method comprising:
establishing, by a telecommunication server, a primary telecommunication session on a primary channel and a secondary telecommunication session on a sub-channel, wherein the primary telecommunication session and the secondary telecommunication session are separate telecommunication sessions that are not joined;
receiving, by the telecommunication server, a secondary rerouting request from a specific secondary participant to the secondary telecommunication session; and
executing, by the telecommunication server, the secondary rerouting request, wherein executing the secondary rerouting request redirects only secondary telecommunication transmissions from the specific secondary participant from the sub-channel to the primary channel, and wherein telecommunication transmissions from other participants to the secondary telecommunication session are unavailable to the primary telecommunication session.

2. The method of claim 1, further comprising:
receiving, by the telecommunication server, a primary rerouting request from a specific primary participant to the primary telecommunication session; and
executing, by the telecommunication server, the primary rerouting request, wherein executing the primary rerouting request redirects only primary telecommunication transmissions from the specific primary participant from the primary channel to the sub-channel, and wherein telecommunication transmissions from other participants to the primary telecommunication session are unavailable to the secondary telecommunication session.

3. The method of claim 1, wherein the primary communication session and the secondary communication session are both audio-only communication sessions.

4. The method of claim 1, wherein the primary communication session and the secondary communication session are both audio-video communication sessions.

5. The method of claim 1, wherein the primary communication session is an audio communication session and the secondary communication session is an audio-video communication session.

6. The method of claim 1, wherein the primary communication session is an audio-video communication session and the secondary communication session is an audio communication session.

7. A computer program product for establishing an embedded side call telecommunication session via a sub-channel in a telecommunication session, the computer program product comprising a non-transitory computer readable storage medium having program code embodied therewith, the program code readable and executable by a processor to perform a method comprising:
establishing, by a telecommunication server, a primary telecommunication session on a primary channel and a secondary telecommunication session on a sub-channel, wherein the primary telecommunication session and the secondary telecommunication session are separate telecommunication sessions that are not joined;
receiving, by the telecommunication server, a secondary rerouting request from a specific secondary participant to the secondary telecommunication session; and
executing, by the telecommunication server, the secondary rerouting request, wherein executing the secondary rerouting request redirects only secondary telecommunication transmissions from the specific secondary participant from the sub-channel to the primary channel, and wherein telecommunication transmissions from other participants to the secondary telecommunication session are unavailable to the primary telecommunication session.

8. The computer program product of claim 7, wherein the method further comprises:
receiving, by the telecommunication server, a primary rerouting request from a specific primary participant to the primary telecommunication session; and
executing, by the telecommunication server, the primary rerouting request, wherein executing the primary rerouting request redirects only primary telecommunication transmissions from the specific primary participant from the primary channel to the sub-channel, and wherein telecommunication transmissions from other participants to the primary telecommunication session are unavailable to the secondary telecommunication session.

9. The computer program product of claim 7, wherein the primary communication session and the secondary communication session are both audio-only communication sessions.

10. The computer program product of claim 7, wherein the primary communication session and the secondary communication session are both audio-video communication sessions.

11. The computer program product of claim 7, wherein the primary communication session is an audio communication session and the secondary communication session is an audio-video communication session.

12. The computer program product of claim 7, wherein the primary communication session is an audio-video communication session and the secondary communication session is an audio communication session.

13. A computer system comprising:
a processor, a computer readable memory, and a non-transitory computer readable storage medium;
first program instructions to establish, by a telecommunication server, a primary telecommunication session on a primary channel and a secondary telecommunication session on a sub-channel, wherein the primary telecommunication session and the secondary telecommunication session are separate telecommunication sessions that are not joined;
second program instructions to receive, by the telecommunication server, a secondary rerouting request from a specific secondary participant to the secondary telecommunication session; and
third program instructions to execute, by the telecommunication server, the secondary rerouting request, wherein executing the secondary rerouting request redirects only secondary telecommunication transmissions from the specific secondary participant from the sub-channel to the primary channel, and wherein telecommunication transmissions from other participants to the secondary telecommunication session are unavailable to the primary telecommunication session;
and wherein
the first, second, and third program instructions are stored on the non-transitory computer readable storage medium for execution by one or more processors via the computer readable memory.

14. The computer system of claim 13, further comprising:
fourth program instructions to receive, by the telecommunication server, a primary rerouting request from a specific primary participant to the primary telecommunication session; and
fifth program instructions to execute, by the telecommunication server, the primary rerouting request, wherein executing the primary rerouting request redirects only primary telecommunication transmissions from the specific primary participant from the primary channel to the sub-channel, and wherein telecommunication transmissions from other participants to the primary telecommunication session are unavailable to the secondary telecommunication session;
and wherein
the fourth and fifth program instructions are stored on the non-transitory computer readable storage medium for execution by one or more processors via the computer readable memory.

15. The computer system of claim 13, wherein the primary communication session and the secondary communication session are both audio-only communication sessions.

16. The computer system of claim 13, wherein the primary communication session and the secondary communication session are both audio-video communication sessions.

17. The computer system of claim 13, wherein the primary communication session is an audio communication session and the secondary communication session is an audio-video communication session.

18. The computer system of claim 13, wherein the primary communication session is an audio-video communication session and the secondary communication session is an audio communication session.
